(19) United States
(12) Patent Application Publication
(10) Pub. No.: US 2026/0020070 A1
(43) Pub. Date: Jan. 15, 2026

(54) DIGITAL TWIN ASSISTED RANDOM ACCESS

(71) Applicant: QUALCOMM Incorporated, San Diego, CA (US)

(72) Inventors: Roohollah AMIRI, San Diego, CA (US); Srinivas YERRAMALLI, San Diego, CA (US); Xiaoxia ZHANG, San Diego, CA (US); Arumugam CHENDAMARAI KANNAN, San Diego, CA (US); Yitao CHEN, San Marcos, CA (US); Vinay CHANDE, San Diego, CA (US); Marwen ZORGUI, San Diego, CA (US); Mohammad Tarek FAHIM, San Diego, CA (US)

(21) Appl. No.: 18/769,126

(22) Filed: Jul. 10, 2024

(51) Int. Cl. H04W 74/0833; H04W 48/08

(52) U.S. Cl. CPC H04W 74/0833; H04W 48/08

(57) ABSTRACT

Methods, systems, and devices for wireless communications are described. A user equipment (UE) may select a random access channel (RACH) resource to access a cell based on measurements of synchronization signal blocks (SSBs) transmitted by the cell. A UE may use a digital twin (DT) entity to verify, augment, and/or replace measurements of SSBs for RACH resource selection. A DT entity may estimate the pathloss of given SSBs transmitted by a given cell at given UE locations with respect to the cell. A UE may send a request to the DT entity for one or more estimated measurement values associated with one or more SSBs for a given cell. Based on the geographic location of the UE, the DT entity may send the requested estimated measurement values to the UE. The UE may select a RACH occasion for transmission of a RACH message based on the provided estimated measurement values.

### FIELD OF TECHNOLOGY

The following relates to wireless communications, including digital twin assisted random access.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include outputting a request for a digital twin (DT) entity associated with a cell to provide, based on a geographic location of the UE, one or more estimated measurement values associated with one or more synchronization signal blocks (SSBs), where the one or more SSBs are associated with the cell, obtaining, from the DT entity and based on the request, a response that indicates the one or more estimated measurement values, and outputting, based on the one or more estimated measurement values, a random access channel (RACH) message to the cell.

A UE for wireless communications is described. The UE may include one or more memories storing processor executable code, and one or more processors coupled with the one or more memories. The one or more processors may individually or collectively be operable to execute the code to cause the UE to output a request for a DT entity associated with a cell to provide, based on a geographic location of the UE, one or more estimated measurement values associated with one or more SSBs, where the one or more SSBs are associated with the cell, obtain, from the DT entity and based on the request, a response that indicates the one or more estimated measurement values, and output, based on the one or more estimated measurement values, a RACH message to the cell.

Another UE for wireless communications is described. The UE may include means for outputting a request for a DT entity associated with a cell to provide, based on a geographic location of the UE, one or more estimated measurement values associated with one or more SSBs, where the one or more SSBs are associated with the cell, means for obtaining, from the DT entity and based on the request, a response that indicates the one or more estimated measurement values, and means for outputting, based on the one or more estimated measurement values, a RACH message to the cell.

A non-transitory computer-readable medium storing code for wireless communications is described. The code may include instructions executable by one or more processors to output a request for a DT entity associated with a cell to provide, based on a geographic location of the UE, one or more estimated measurement values associated with one or more SSBs, where the one or more SSBs are associated with the cell, obtain, from the DT entity and based on the request, a response that indicates the one or more estimated measurement values, and output, based on the one or more estimated measurement values, a RACH message to the cell.

In some examples of the method, UEs, and non-transitory computer-readable medium described herein, and the method, apparatuses, and non-transitory computer-readable medium may include further operations, features, means, or instructions for one or more generated measurement values associated with the one or more SSBs and associated indices of the one or more SSBs; an identifier of the cell; an indication of a transmission power level of the one or more SSBs; an estimate of the geographic location of the UE; a velocity of the UE; a trajectory of the UE; or antenna information associated with the UE.

Some examples of the method, UEs, and non-transitory computer-readable medium described herein may further include operations, features, means, or instructions for identifying the geographic location of the UE and identifying, based on the geographic location of the UE, the DT entity, where outputting the request may be based on identifying the DT entity.

Some examples of the method, UEs, and non-transitory computer-readable medium described herein may further include operations, features, means, or instructions for generating one or more measurement values of the one or more SSBs based on obtaining the one or more SSBs from the cell, and where the response includes one or more of: an estimated pathloss value of each of the one or more SSBs; an estimated pathloss of one or more additional SSBs associated with the cell; an offset value for each of the one or more SSBs in comparison to the one or more measurement values; a validity window associated with the one or more estimated measurement values; a suggested SSB associated with the cell; a recommendation for the UE to perform additional measurements associated with the cell prior to outputting the RACH message; a recommendation for the UE to skip one or more additional measurements associated with the cell prior to outputting the RACH message; or a timing advance to apply to the RACH message.

Some examples of the method, UEs, and non-transitory computer-readable medium described herein may further include operations, features, means, or instructions for identifying a failure of the RACH message, where the RACH message may be associated with a first transmission power level and outputting, subsequent to the RACH message, a second RACH message, where the second RACH message may be associated with a second transmission power level, and where the response may be indicative of the second transmission power level.

In some examples of the method, UEs, and non-transitory computer-readable medium described herein, outputting the second RACH message may include operations, features, means, or instructions for outputting the second RACH message via a second RACH occasion, where outputting the RACH message includes outputting the RACH message via a first RACH occasion, and where the response indicates the second RACH occasion.

Some examples of the method, UEs, and non-transitory computer-readable medium described herein may further include operations, features, means, or instructions for generating one or more measurement values associated with the one or more SSBs based on obtaining the one or more SSBs from the cell, where the response indicates a confidence level associated with the one or more estimated measurement values and selecting a SSB based on the one or more measurement values, the one or more estimated measurement values, the confidence level, or a combination thereof, where outputting the RACH message includes outputting the RACH message via a RACH occasion associated with the SSB.

In some examples of the method, UEs, and non-transitory computer-readable medium described herein, selecting the SSB may include operations, features, means, or instructions for selecting the SSB based on the one or more estimated measurement values based on the confidence level exceeding a threshold level.

Some examples of the method, UEs, and non-transitory computer-readable medium described herein may further include operations, features, means, or instructions for augmenting the one or more measurement values based on the one or more estimated measurement values and based on the confidence level exceeding a threshold level, where selecting the SSB may be based on the augmented one or more measurement values.

Some examples of the method, UEs, and non-transitory computer-readable medium described herein may further include operations, features, means, or instructions for generating, based on a confidence level indicated by the response being below a threshold level, one or more measurement values associated with the one or more SSBs or one or more additional SSBs associated with the cell based on obtaining the one or more SSBs or the one or more additional SSBs from the cell, where the confidence level may be associated with the one or more estimated measurement values and selecting a SSB based on the one or more measurement values, where outputting the RACH message includes outputting the RACH message via a RACH occasion associated with the SSB.

Some examples of the method, UEs, and non-transitory computer-readable medium described herein may further include operations, features, means, or instructions for identifying that the cell will not transmit the one or more SSBs during a period of time, where outputting the request may be based on the identifying.

In some examples of the method, UEs, and non-transitory computer-readable medium described herein, outputting the request may include operations, features, means, or instructions for outputting the request to the DT entity stored in memory of the UE, and where obtaining the response includes obtaining the response from the DT entity stored in the memory of the UE.

In some examples of the method, UEs, and non-transitory computer-readable medium described herein, outputting the request may include operations, features, means, or instructions for outputting, via a network connection, the request to an external server hosting the DT entity, and where obtaining the response includes obtaining the response via the network connection from the external server hosting the DT entity.

Some examples of the method, UEs, and non-transitory computer-readable medium described herein may further include operations, features, means, or instructions for outputting, to the cell and after performing a random access procedure with the cell, first control signaling that indicates a capability of the UE to use the DT entity to receive estimated measurements for the cell and obtaining, from the cell and based on the first control signaling, second control signaling that indicates a measurement reporting configuration associated with the DT entity.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports digital twin (DT) assisted random access in accordance with one or more aspects of the present disclosure.

FIG. 2 shows an example of a wireless communications system that supports DT-assisted random access in accordance with one or more aspects of the present disclosure.

FIG. 3 shows an example of a synchronization signal block measurement estimate consumption diagram that supports DT-assisted random access in accordance with one or more aspects of the present disclosure.

FIG. 4 shows an example of a process flow that supports DT-assisted random access in accordance with one or more aspects of the present disclosure.

FIGS. 5 and 6 show block diagrams of devices that support DT-assisted random access in accordance with one or more aspects of the present disclosure.

FIG. 7 shows a block diagram of a communications manager that supports DT-assisted random access in accordance with one or more aspects of the present disclosure.

FIG. 8 shows a diagram of a system including a device that supports DT-assisted random access in accordance with one or more aspects of the present disclosure.

FIGS. 9 and 10 show flowcharts illustrating methods that support DT-assisted random access in accordance with one or more aspects of the present disclosure.

### DETAILED DESCRIPTION

In wireless communications systems, a user equipment (UE) may monitor for synchronization signal blocks (SSBs) from a cell as a part of an initial cell search. A cell may transmit SSBs via multiple beams (e.g., may perform beam sweeping of SSBs), and the UE may measure the SSBs to select a cell and beam to access based on the measurements of the SSBs. For example, a network entity may periodically transmit a burst of SSBs via a set of beams (e.g., up to 64 indexed SSBs). In some examples, an SSB may be transmitted over 4 symbols. An SSB may include a primary synchronization signal (PSS) in a first symbol, a physical broadcast channel (PBCH) transmitted over the subsequent three symbols, and a secondary synchronization signal (SSS) multiplexed with the PBCH transmission on the third symbol. The PSS and the SSS together may indicate the cell ID (e.g., the physical cell identifier (PCI)) of the cell that transmitted the SSB. The UE also may use the PSS and SSS to synchronize timing with the cell and to decode the PBCH transmission. The PBCH transmission may convey a master information block (MIB) which may include system information (SI) for the cell and may include scheduling information for a physical downlink control channel (PDCCH) occasion for the UE to monitor. The PDCCH transmission in the indicated PDCCH occasion may include scheduling information for a physical downlink shared channel (PDSCH) transmission that includes SI in addition to the MIB (e.g., a system information block 1 (SIB1)) for the cell. The UE may use the SSB and the SI on the PDSCH transmission to perform initial access with the cell. For example, SIB1 may be referred to as remaining minimum system information (RMSI).

SSBs may be mapped to different random access channel (RACH) occasions, for example, in SI such as the SIB1. The UE may select a RACH occasion to transmit an initial RACH message based on measurements (e.g., received signal strength indicator (RSSI) measurements) of SSBs. Transmission of SSBs may be power intensive at the network side. UEs may not have abilities to verify SSB measurements, for example, other than repeating measurements of subsequent periodic transmissions of the SSBs. Repeating SSB measurements for verification purposes may increase latency as repetition of SSB measurements may involve waiting for a next periodic transmission of a given SSB.

A UE may use digital twin (DT) models to verify and/or replace UE measurements of SSBs for RACH resource selection. For example, a DT model for a cell may be a model of the cell that may provide estimates of the pathloss of given SSBs transmitted by the cell at given geographic locations of the receiving UE with respect to the cell. A DT entity may store a DT model for a cell. In some examples, a DT entity may be hosted at a server, which a UE may access on demand. For example, a UE may access an externally hosted DT entity via an internet connection such as a Wi-Fi connection. As another example, a DT entity may be stored in memory of the UE (e.g., downloaded from the network while the UE was previously connected to the network).

The UE may send a request to the DT entity for one or more estimated measurement values (e.g., estimated RSSIs or pathloss values) associated with one or more SSBs for a given cell. Based on the geographic location of the UE, which may be indicated in the request (e.g., based on Global Navigation Satellite Systems (GNSS) or Global Positioning System (GPS) signals, or based on a nearby Wi-Fi access point (AP)) or may be determined by the DT entity (e.g., via a mobility management entity (MME) or an access and mobility function (AMF) of the network), the DT entity may send the requested estimated measurement values to the UE. The UE may accordingly select a RACH occasion for transmission of a RACH message (e.g., a msg1 or a msgA) based on the provided estimated measurement values. In some examples, the DT entity may provide a confidence level associated with the estimated measurement values, and whether the UE solely relies upon the estimated measurement values, augments actual SSB measurements with the estimated measurement values, solely relies on the actual SSB measurements, and/or performs additional SSB measurements may depend on the indicated confidence level.

Aspects of the disclosure are initially described in the context of wireless communications systems. Aspects of the disclosure are further illustrated by and described with reference to SSB measurement estimate consumption diagrams, process flows, apparatus diagrams, system diagrams, and flowcharts that relate to DT-assisted random access.

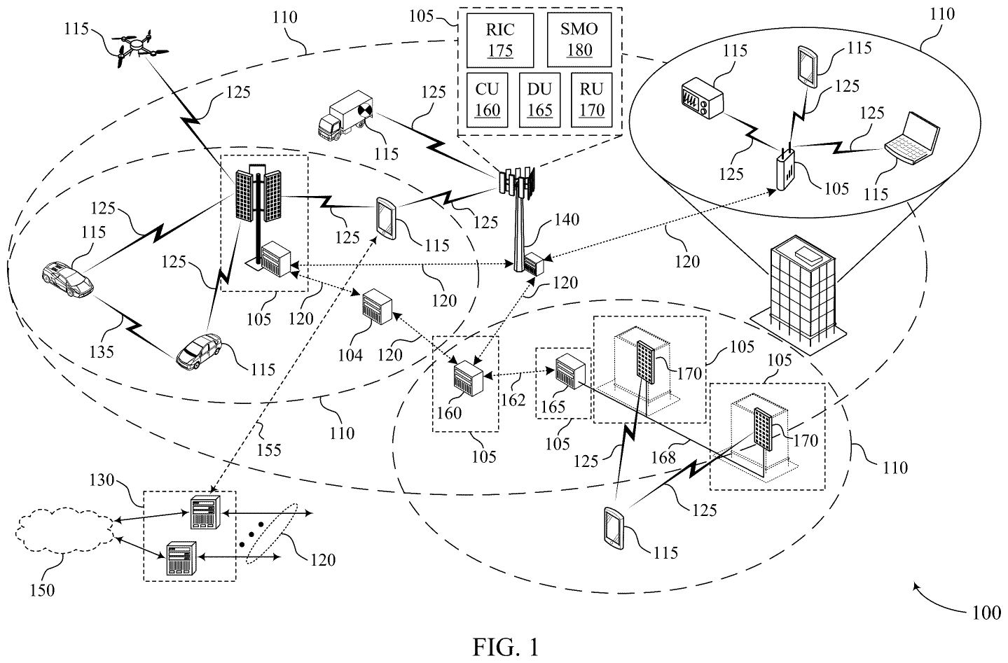

FIG. 1 shows an example of a wireless communications system 100 that supports DT-assisted random access in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., an MME, an AMF) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In the wireless communications system 100, UEs 115 may monitor for SSBs from a cell (e.g., a cell served by a network entity 105) to perform initial cell search. The cell may transmit SSBs via multiple beams, and the UE 115 may measure the SSBs to select a cell and beam to access. SSBs may be mapped to different RACH occasions, and a UE 115 may select a RACH occasion based on measurements of the SSBs.

In some examples, a UE 115 may use a DT entity to verify, augment, and/or replace measurements of SSBs, for example, for RACH resource selection. For example, a DT entity may store or may be a model of a given cell that may estimate the pathloss of given SSBs transmitted by the given cell at given geographic locations of a UE with respect to the cell. In some examples, a DT entity may be hosted at a server, which a UE may access, for example, via a Wi-Fi connection. As another example, a DT entity may be stored in memory of the UE 115 (e.g., downloaded from the network while the UE 115 was previously connected to the network). The UE 115 may send a request to the DT entity for one or more estimated measurement values (e.g., estimated RSSIs or pathloss values) associated with one or more SSBs for a given cell. Based on the geographic location of the UE 115, which may be indicated in the request (e.g., based on GNSS or GPS signals or based on a nearby Wi-Fi AP) or may be determined by the DT entity (e.g., via an MME or an AMF function of the network), the DT entity may send the requested estimated measurement values to the UE 115. The UE 115 may accordingly select a RACH occasion for transmission of a RACH message (e.g., a msg1 or a msgA) based on the provided estimated measurement values.

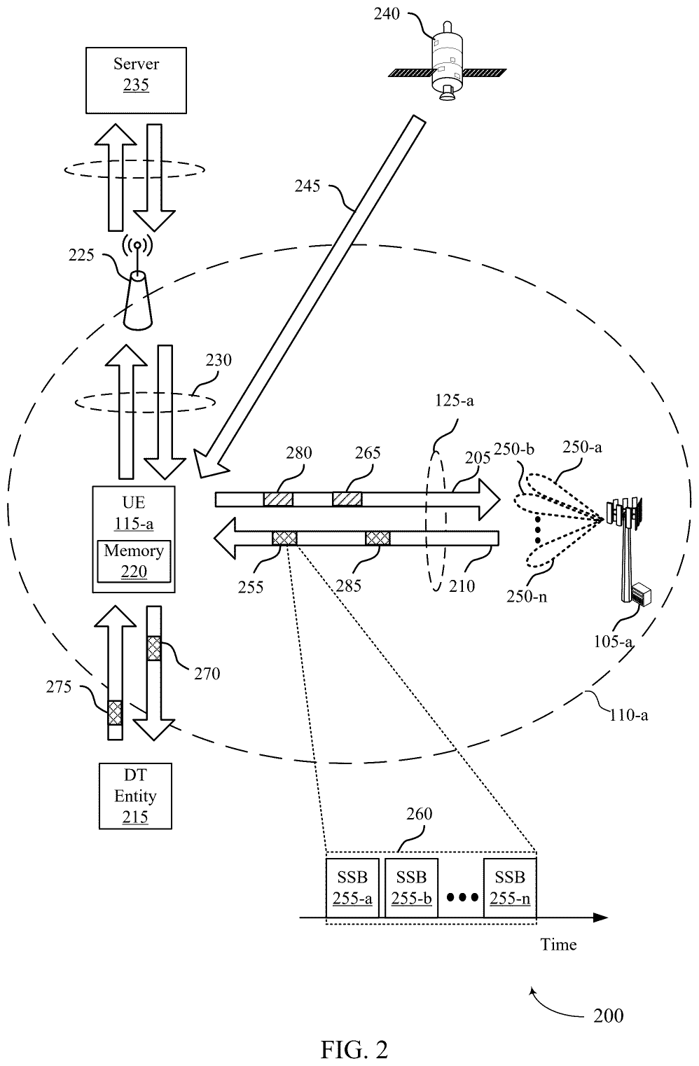

FIG. 2 shows an example of a wireless communications system 200 that supports DT-assisted random access in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include a bi-directional link that enable both uplink and downlink communications. For example, the UE 115-a may transmit uplink signals 205 (e.g., uplink transmissions), such as uplink control signals or uplink data signals, to the network entity 105-a using the communication link 125-a and the network entity 105-a may transmit downlink signals 210 (e.g., downlink transmissions), such as downlink control signals or downlink data signals, to the UE 115-a using the communication link 125-a.

The network entity 105-a may transmit SSBs 255 via beams 250 (e.g., a first SSB 255-a via a beam 250-a, a second SSB 255-b via a second beam 250-b, . . . , and an nth SSB 255-n via an nth beam 250-n). For example, the network entity 105-a may perform beam sweeping techniques in which the network entity transmits the SSBs 255 via the beams 250 during periodic SSB bursts 260. Each SSB 255 transmitted in an SSB burst 260 may have a different respective SSB index. The UE 115-a may perform measurements on SSBs 255 (e.g., perform RSSI measurements, SSB reference signal received power (RSRP) measurements, or pathloss measurements). The SSBs 255 may be mapped to corresponding RACH occasions. The UE 115-a may select a RACH occasion for a RACH message 265 based on measurements of the SSBs 255. As described herein, transmission of SSBs 255 may be power intensive at the network entity 105-a. The UE 115-a may not have abilities to verify SSB measurements, for example, other than repeating measurements in subsequent SSB bursts 260, which may increase latency as repetition of measurements may involve waiting for a next periodic transmission of a given SSB.

To verify and/or replace measurements of SSB 255 for RACH resource selection, the UE 115-a may use a DT entity 215. For example, the UE 115-a may send a request 270 to the DT entity 215 for one or more estimated measurement values (e.g., estimated RSSIs, SSB RSRPs, or pathloss values) associated with one or more SSBs 255 associated with a cell. Based on the geographic location of the UE 115-a, the DT entity 215 may send a response 275 to the UE 115-a that indicates the requested estimated measurement values for the SSBs 255. For example, the DT entity 215 may store estimated SSB measurement values for various geographic locations within a coverage area 110-a served by a given cell associated with the DT entity 215.

In some examples, the request 270 may include an indication of the geographic location of the UE 115-a. In some examples, the UE 115-a may receive positioning signals 245, such as GNSS or GPS signals, from one or more satellites 240. The UE 115-a may determine the geographic location of the UE 115-a based on the positioning signals 245, and the UE 115-a may include the determined geographic location in the request 270.

In some examples, the UE 115-a may be in communication with an AP 225 (e.g., a Wi-Fi AP). For example, the UE 115-a may establish a communication link 230 with the AP 225. In some examples, the UE 115-a may determine the geographic location of the UE 115-a based on the communication link 230 with the AP 225, and the and the UE 115-a may include the determined geographic location in the request 270.

The AP 225 may provide a connection to IP services 150 as described herein. In some examples, the DT entity 215 may be stored on a server 235 which the UE 115-a may access via the communication link 230 with the AP 225. For example, the UE 115-a may transmit the request 270 and may receive the response 275 via the communication link 230. In some examples, the DT entity 215 may determine the location of the UE 115-a based on the request 270. For example, the request 270 may include an indication of an identifier for the UE 115-a, and the DT entity 215 may have access to the core network 130 as described herein. For example, the DT entity 215 may request positioning information from an AMF of the core network 130 based on the identifier of the UE 115-a.

In some examples, the DT entity 215 may be stored locally at the UE 115-a, for example, in memory 220 of the UE 115-. For example, when the UE 115-a is connected to a cell, the cell may provide, and the UE 115-a may store in memory 220, one or more DT entities 215 for neighboring cells such that the UE 115-a may use the DT entities for initial access to the neighboring cells. In some examples, the UE 115-a may identify which DT entity 215 to send a request to based on the geographic location of the UE 115-a. For example, based on the determined geographic location of the UE 115-a, the UE 115-a may determine that the UE 115-a is within the coverage area 110-a of a given cell, and the UE 115-a may identify the DT entity 215 that models the identified cell. In some examples, the UE 115-a may store multiple DT entities including the DT entity 215 in memory 220. For example, the multiple DT entities may be stored in memory as a pre-downloaded map, for example, for areas that the UE 115-a frequently visits. For example, the pre-downloaded map stored in memory 220 may store estimated SSB measurements at different locations on the pre-downloaded map.

In some examples, the UE 115-a may use the DT entity 215 for validation of measurements of the SSBs 255 that the UE 115-a performed. For example, the UE 115-a may perform measurements on the SSBs 255. The UE 115-a may subsequently send the request 270 to the DT entity 215 for estimated or predicted measurements (such as RSSI measurements, SSB RSRP measurements, or pathloss estimates) for the cell. In some examples, the request 270 may indicate a purpose of the request, such as validation of measurements performed by the UE 115-a or for estimated measurements in the absence of actual measurements performed by the UE 115-a. In some examples (e.g., in validation cases), the request 270 may include the actual measurements performed by the UE 115-a (e.g., measured SSB-RSRPs and the associated SSB beam indices for the SSBs 255). In some examples, the request may include cell information, such as the PCI and identification and/or the SSB power (e.g., for the DT entity to estimate the transmission power at the transmission and reception point (TRP) of the cell). In some examples, as described herein, the request 270 may include the determined or estimated geographic location of the UE 115-a. In some examples, the request 270 may include velocity and/or trajectory data for the UE 115-a. In some examples, the request 270 may include other information regarding the UE 115-a, such as the quantity of receive antennas at the UE 115-a and/or the beam configuration at the UE 115-a used to compute the SSB measurements.

In some examples, the response 275 may indicate estimated pathlosses for the SSBs 255 for which the UE 115-a included actual measurements in the request 270. In some examples, the response 275 may include estimated pathlosses for one or more additional SSBs 255 (e.g., in addition to the SSBs 255 for which the UE 115-a included actual measurements in the request 270). In some examples, the response 275 may include a confidence value (also referred to as a likelihood value) which may indicate the confidence of the DT entity 215 in the estimated values. For example, the accuracy of the estimates by the DT entity 215 may depend on radio conditions and/or the precision of the DT model (e.g., the location granularity used for estimated measurements). In some examples, the response 275 may include a mean and variance value, which may represent a distribution for the estimated measurements provided by the DT entity 215 in the response 275. In some examples, the DT entity 215 may indicate the estimated measurements as an offset to the actual measurements provided by the UE 115-a in the request 270. In some examples, the response 275 may indicate a time validity window during which the information provided in the response 275 may be considered accurate. For example, the time validity window may be based on UE velocity information (e.g., a UE velocity vector). In some examples, the response 275 may include suggested alternative SSB beams (e.g., other than the SSBs 255 for which the UE 115-a requested estimated measurements in the request 270). In some examples, the response 275 may include a recommendation for the UE 115-a to perform additional SSB measurements before performing an initial access procedure with the cell (e.g., based on a low confidence value and/or based on no SSB satisfying a threshold measurement value). In some examples, the response 275 may include a recommendation for the UE 115-a to skip or reduce future measurements of SSBs for the cell (e.g., based on a high confidence value or based on one or more SSBs 255 satisfying a threshold measurement value). In some examples, the response 275 may include an estimate of the timing advance to use for the RACH message 265. In some examples, if the DT entity 215 is unable to provide estimated measurements for the SSBs indicated in the request 270, the response 275 may indicate an error and/or a reason for the error.

In some examples, the response 275 may indicate a value or range for a RACH power ramping step, for example, if a first transmission of the RACH message 265 fails. For example, the UE 115-a may transmit the RACH message 265 in a first RACH occasion using a first transmission power level, and if the transmission of the RACH message 265 in the first RACH occasion fails (e.g., the UE 115-a does not receive a response such as a msgB or a msg2 from the cell), the UE 115-a may transmit the RACH message 265 (e.g., another msg1 or msgA) in a second RACH occasion using an increased transmission power level in accordance with the indicated RACH power ramping. In some examples, the response 275 may include a recommendation of an alternative RACH resource associated with a different SSB beam if the RACH message 265 in the first RACH occasion fails. In some examples, the UE 115-a may attempt to transmit the RACH message 265 in a different RACH occasion associated with a different SSB before performing RACH power ramping.

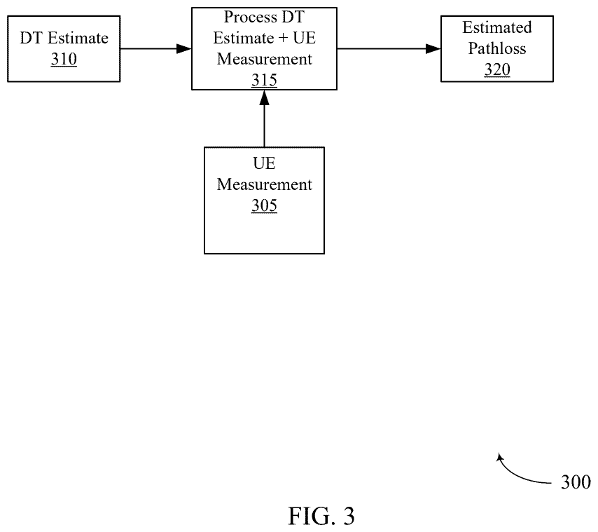

In some examples, the UE 115-a may use actual measurements of SSBs 255 for determining the RACH occasion to use for the RACH message 265, for example, if the response 275 indicates a low confidence level or if an actual measurement of an SSB 255 satisfies a measurement threshold (e.g., has a high RSRP or RSSI). In some examples, as described with reference to FIG. 3, the UE 115-a may use the estimated measurements provided in the response 275 to augment the actual measurements of the SSBs 255 performed by the UE 115-a. In some examples, the UE 115-a may use only the estimated measurement values provided in the response for determining the RACH occasion to use for the RACH message 265, for example, if the response 275 indicates a high confidence level. As another example, a given cell may refrain from transmitting SSBs 255 (or a subset of all of the SSBs associated with the cell) to save power and/or may transmit SSBs 255 (or a subset of all of the SSBs associated with the cell) at a low periodicity. The UE 115-a may determine that the cell is refraining from transmitting SSBs, for example, based on other SI received from the cell. For example, if the cell refrains from transmitting a subset of the SSBs, the master information block (MIB) in the SSBs that are transmitted may indicate that the cell is refraining from transmitting some of the expected SSBs. As another example, the UE 115-a may determine that the cell is refraining from transmitting one or more expected SSBs based on not receiving the one or more SSBs from the cell within an expected time window. In some examples, the UE 115-a may receive an indication from a neighboring cell that the cell is refraining from transmitting SSBs 255. In such cases where the cell may refrain from transmitting one or more SSBs 255 or transmits one or more SSBs 255 at a lower periodicity, the UE 115-a may use only the estimated measurements of those SSBs 255 for determining the RACH occasion to use for the RACH message 265 for those SSBs 255.

In some examples, the UE 115-a may perform additional measurements of SSBs 255 after receiving the response 275 (e.g., if the response 275 indicates a low confidence level or if no SSB measurement satisfies a measurement threshold). In some examples, the UE 115-a may skip additional measurements of SSBs 255 after receiving the response 275 (e.g., if the response 275 indicates a high confidence level or if an SSB measurement satisfies a measurement threshold).

In some examples, the UE 115-a may use timing information provided in the response 275 to pre-compensate for UE timing before transmission of the RACH message 265. For example, the response 275 may indicate a suggested timing advance for the UE 115-a to apply to the RACH message 265, which may improve detection capability of the RACH message 265 at the network entity 105-a, especially for large cells. Based on the final calculated pathloss associated with the SSBs (e.g., based on the actual measurements and/or the estimated measurements in the response 275), the UE 115-a may select a transmission power, a timing advance, and a RACH resource (e.g., a RACH occasion) for uplink transmission of the RACH message 265.

The UE 115-a may estimate the amount of time to send the request 270 and receive the response 275. In some examples, if the estimated amount of time is small (e.g., sub milliseconds), the UE 115-a may use the response 275 to manage SSB measurements within the same SSB-based RRM Measurement Timing Configuration (SMTC) window as the request 270. In some examples, if the estimated amount of time is larger (e.g., involves more than one SMTC window), the UE 115-a may use the information in the response 275 to determine whether to perform additional SSB measurements or to start transmission of the RACH message 265.

In some examples, the UE 115-a may determine how to use, augment, or disregard estimated measurements from the DT entity 215 (e.g., provided in the response). In some examples, the network entity 105-a may enforce requirements or configurations on the use of DT services for the UE 115-a. For example, after connecting to a cell served by the network entity 105-a (e.g., in accordance with a RACH procedure that includes the RACH message 265), the UE 115-a may transmit capability signaling 280 to the network entity 105-a. The capability signaling 280 may indicate the capability of the UE 115-a to use DT services (e.g., the DT entity 215). For example, the UE 115-a may receive additional beam measurement estimates (e.g., SSB or CSI-RS measurements) from the DT entity 215 based on the geographic location of the UE 115-a. As another example, the UE 115-a may receive estimated neighbor cell measurements from the DT entity 215 based on the geographic location of the UE 115-a. Accordingly, the UE 115-a may perform beam management and or mobility procedures based on information received from the DT entity 215 after initial access to a cell. The UE 115-a may report such capabilities in the capability signaling 280.

The network entity 105-a may transmit control signaling 285 (e.g., in response to the capability signaling 280) that configures one or more aspects of use of the DT services at the UE 115-a. For example, the control signaling 285 may configure how the UE 115-a may use outputs/estimates provided by the DT entity 215. For example, the control signaling 285 may configure the UE 115-a to tag reports that are based on DT estimates. As another example, the control signaling 285 may configure a set of coefficients for the UE 115-a to use when augmenting actual measurements performed by the UE 115-a with estimated measurements provided by the DT entity 215. For example, the coefficients may be similar to coefficients the network entity may configure for the UE to calculate a filtered RSRP. For example, the UE 115-a may calculate an augmented measurement to include in a report (e.g., for a given beam in a beam report) as Measurement_{augmented}=((1−a)×DTₑₛₜᵢₘₐₜₑ)+(a×Measurement_{actual}), where Measurement_{augmented} is the augmented measurement, a is the configured coefficient, DTₑₛₜᵢₘₐₜₑ is the estimated measurement provided by the DT entity 215, and Measurement_{actual} is the actual measurement performed by the UE 115-a. In some examples, the control signaling 285 may configure a=1, in which case the UE 115-a may be configured to only report actual measurements or to use actual measurements in calculation of filtered metrics. As another example, the control signaling 285 may configure a=0, in which case the UE 115-a may be configured to only report estimates provided by the DT entity 215 or to use estimates provided by the DT entity 215 in calculation of filtered metrics.

In some examples, the UE 115-a may similarly use a coefficient to calculate estimated SSB measurements for initial access. For example, when augmenting the actual SSB measurements with estimates provided by the DT entity, the UE 115-a may calculate a given augmented SSB measurement as Measurement_{augmented}=((1−a)×DTₑₛₜᵢₘₐₜₑ)+(a×Measurement_{actual}). In some examples, the coefficient a used for determining augmented SSB measurements for initial cell access may be preconfigured or predefined (e.g., by a prior cell which the UE 115-a accessed) or may be determined by the UE 115-a (e.g., based on determined radio conditions and/or the confidence level indicated in the response 275).

FIG. 3 shows an example of an SSB measurement estimate consumption diagram 300 that supports DT-assisted random access in accordance with one or more aspects of the present disclosure. The SSB measurement estimate consumption diagram 300 may implement or may be implemented by aspects of the wireless communications system 100 or the wireless communications system 200.

In some examples, as described herein, a UE 115 may augment actual measurements performed by the UE 115 with estimates provided by a DT entity 215. For example, for a given SSB, the UE 115 may perform a measurement 305 on the received SSB. The UE 115 may receive an estimated measurement 310 of the SSB from the DT entity 215. The UE 115 may perform processing 315 of the measurement 305 and the estimated measurement 310 (e.g., based on the likelihood value of the estimated measurement 310 indicated by the DT entity 215) to augment the measurement 305 and derive a combined measurement 320. For example, the combined measurement 320 may be an estimated pathloss for the SSB.

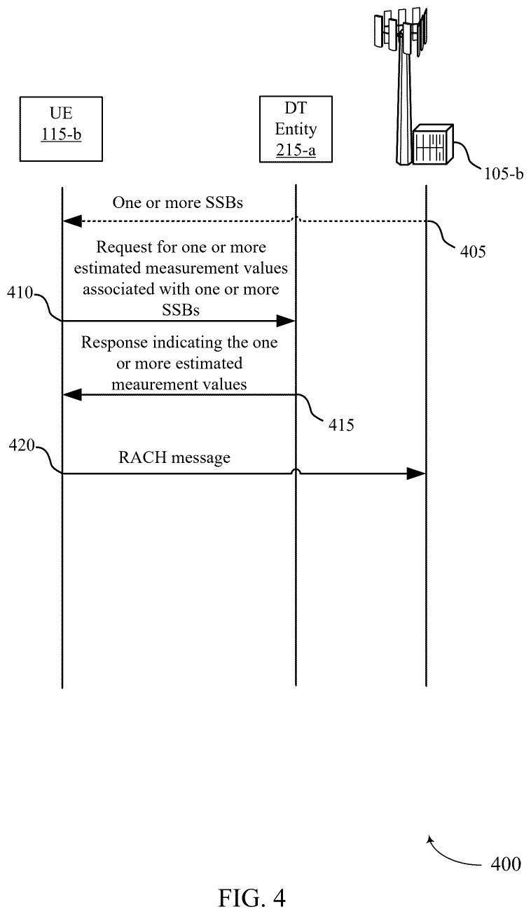

FIG. 4 shows an example of a process flow 400 that supports DT-assisted random access in accordance with one or more aspects of the present disclosure. The process flow 400 may include a UE 115-b and a network entity 105-b, which may be examples of a UE 115 and a network entity 105 as described herein. The process flow 400 may include a DT entity 215-a, which may be an example of a DT entity 215 as described herein. In the following description of the process flow 400, the operations between the UE 115-b, the DT entity 215-a, and the network entity 105-b may be transmitted in a different order than the example order shown, or the operations performed by the UE 115-b, the DT entity 215-a, and the network entity 105-b may be performed in different orders or at different times. Some operations may also be omitted from the process flow 400, and other operations may be added to the process flow 400.

At 410, the UE 115-b may output a request to the DT entity 215-a for the DT entity 215-a to provide one or more estimated measurement values associated with one or more SSBs. The DT entity 215-a may be associated with a cell serviced by the network entity 105-b. The request at 410 may be based on a geographic location of the UE 115-b. The one or more SSBs may be associated with the cell.

At 415, the UE 115-b may obtain, from the DT entity 215-a and based on the request, a response that indicates the one or more estimated measurement values.

At 420, the UE 115-b may output, based on the one or more estimated measurement values in the response, a RACH message to the network entity 105-b (e.g., to the cell serviced by the network entity 105-b).

In some examples, at 405, prior to the request at 410, the UE 115-b may receive the one or more SSBs from the network entity 105-b.

In some examples, the request may include one or more of: one or more generated measurement values associated with the one or more SSBs and associated indices of the one or more SSBs (e.g., based on receiving the SSBs at 405); an identifier of the cell; an indication of a transmission power level of the one or more SSBs; an estimate of the geographic location of the UE 115-b; a velocity of the UE 115-b; a trajectory of the UE 115-b; or antenna information associated with the UE 115-b.

In some examples, the UE 115-b may identify the geographic location of the UE 115-b. For example, the UE 115-b may identify the geographic location of the UE 115-b based on GNNS or GPS signals or based on a Wi-Fi connection. The UE 115-b may identify the DT entity 215-a based on the identified geographic location of the UE 115-b. For example, the UE 115-b may identify a coverage area associated with the cell based on the identified geographic location, and accordingly the UE 115-b may identify the DT entity 215-a as corresponding to the identified cell or coverage area. The UE 115-b may output the request based on identifying the DT entity 215-a.

In some examples, the UE 115-b may generate one or more measurement values of the one or more SSBs based on receiving the SSBs at 405. In some such examples, the response at 415 may include one or more of: an estimated pathloss value of each of the one or more SSBs; an estimated pathloss of one or more additional SSBs associated with the cell; an offset value for each of the one or more SSBs in comparison to the one or more measurement values; a validity window associated with the one or more estimated measurement values; a suggested SSB associated with the cell; a recommendation for the UE 115-b to perform additional measurements associated with the cell prior to outputting the RACH message; a recommendation for the UE 115-b to skip one or more additional measurements associated with the cell prior to outputting the RACH message; or a timing advance to apply to the RACH message.

In some examples, the UE 115-b may identify a failure of the RACH message at 420, where the RACH message is associated with a first transmission power level. For example, the UE 115-b may transmit the RACH message at 420 using the first transmission power level. In such examples, the UE 115-b may transmit, subsequent to the RACH message, a second RACH message, where the second RACH message is associated with a second transmission power level. For example, the response at 415 may be indicative of the second transmission power level to use in the event the first RACH message fails. In some such examples, the UE 115-b may transmit the second RACH message via a second RACH occasion, the UE 115-b may output the RACH message at 420 via a first RACH occasion, and the response at 415 may indicate the second RACH occasion to use in the event the first RACH message fails.

In some examples, the UE 115-b may generate one or more measurement values associated with the one or more SSBs based on receiving the one or more SSBs from the cell at 405. In some such examples, the response at 415 may indicate a confidence level associated with the one or more estimated measurement values, and the UE 115-b may select a SSB based on the one or more measurement values, the one or more estimated measurement values, the confidence level, or any combination thereof. In such examples, the UE 115-b may output the RACH message via a RACH occasion associated with (e.g., mapped to) the SSB. In some examples, the UE 115-b may select the SSB based on the one or more estimated measurement values in accordance with the confidence level exceeding a threshold level. In some examples, the UE 115-b may augment the one or more measurement values based on the one or more estimated measurement values and based on the confidence level exceeding a threshold level, and selecting the SSB may be based on the augmented one or more measurement values.

In some examples, the response at 415 may indicate a confidence level associated with the one or more estimated measurement values. In such examples, the UE 115-b may generate, based on the confidence level being below a threshold level, one or more measurement values associated with the one or more SSBs or one or more additional SSBs associated with the cell based on obtaining the one or more SSBs or the one or more additional SSBs from the cell. The UE 115-b may select a SSB based on the one or more measurement values, and the UE 115-b may output the RACH message via a RACH occasion associated with the selected SSB.

In some examples, the UE 115-b may identify that the cell will not transmit the one or more SSBs during a period of time, and outputting the request at 410 may be based on the identifying that the cell will not transmit the one or more SSBs during the period of time.

In some examples, the DT entity 215-a may be stored in memory of the UE 115-b, and the UE 115-b may output the request at 410 to the DT entity 215-a stored in memory of the UE 115-b and may receive the response at 415 from the DT entity 215-a stored in memory of the UE 115-b.

In some examples, the UE 115-b may output, via a network connection, the request at 410 to an external server that hosts the DT entity 215-a. In such examples, the UE 115-b may receive the response at 415 via the network connection from the external server that hosts the DT entity 215-a.

In some examples, the UE 115-b may transmit, to the cell (e.g., via the network entity 105-b) and after performing a random access procedure with the cell, first control signaling that indicates a capability of the UE 115-b to use the DT entity 215-a to obtain estimated measurements for the cell. In such examples, the UE 115-b may receive, from the cell (e.g., via the network entity 105-b) and based on the control signaling, second control signaling that indicates a measurement reporting configuration associated with the DT entity 215-a. For example, the UE 115-b may use the DT entity 215-a for additional RRM, beam management, or mobility management.

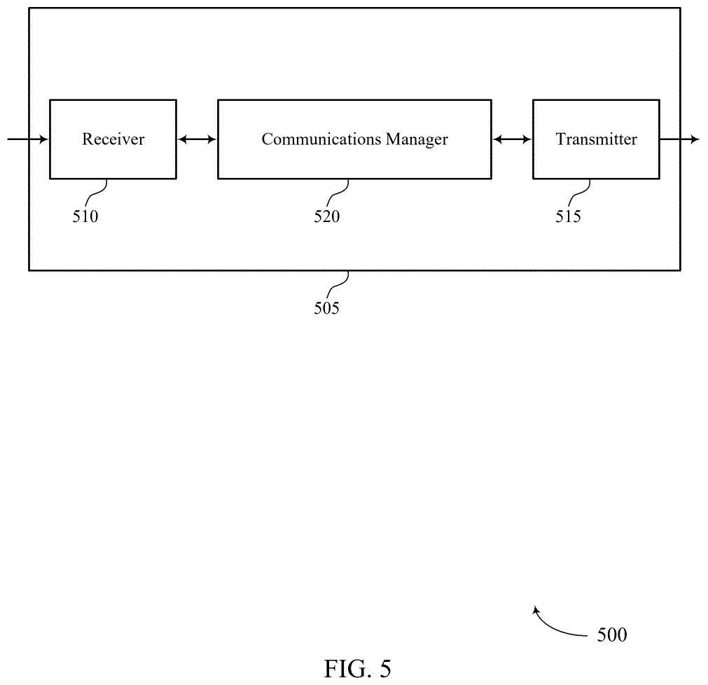

FIG. 5 shows a block diagram 500 of a device 505 that supports DT-assisted random access in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to DT-assisted random access). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to DT-assisted random access). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of DT-assisted random access as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for outputting a request for a DT entity associated with a cell to provide, based on a geographic location of the UE, one or more estimated measurement values associated with one or more SSBs, where the one or more SSBs are associated with the cell. The communications manager 520 is capable of, configured to, or operable to support a means for obtaining, from the DT entity and based on the request, a response that indicates the one or more estimated measurement values. The communications manager 520 is capable of, configured to, or operable to support a means for outputting, based on the one or more estimated measurement values, a RACH message to the cell.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, or more efficient utilization of communication resources.

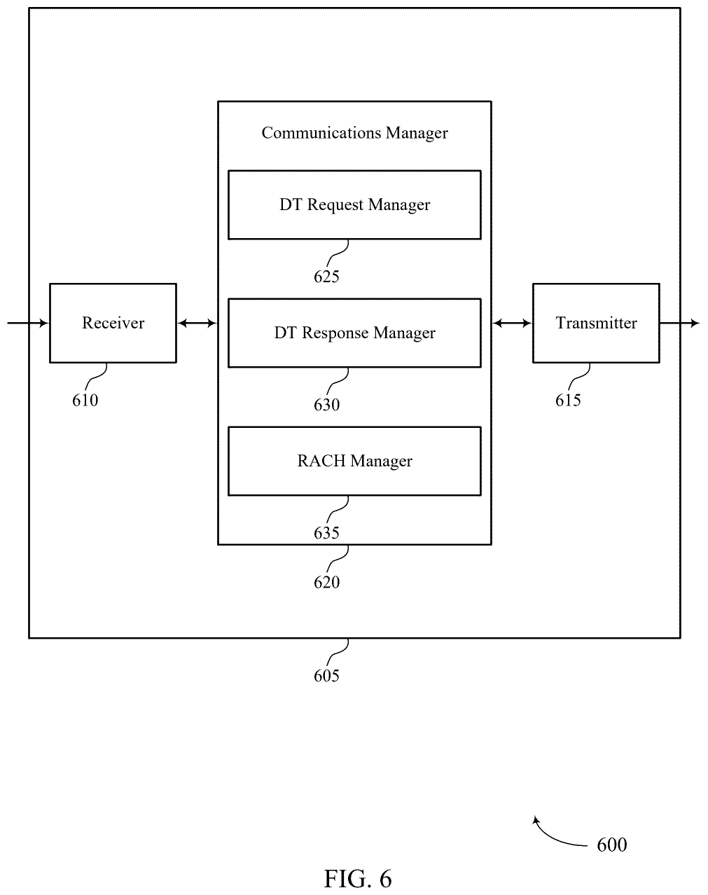

FIG. 6 shows a block diagram 600 of a device 605 that supports DT-assisted random access in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to DT-assisted random access). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to DT-assisted random access). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of DT-assisted random access as described herein. For example, the communications manager 620 may include a DT request manager 625, a DT response manager 630, a RACH manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The DT request manager 625 is capable of, configured to, or operable to support a means for outputting a request for a DT entity associated with a cell to provide, based on a geographic location of the UE, one or more estimated measurement values associated with one or more SSBs, where the one or more SSBs are associated with the cell. The DT response manager 630 is capable of, configured to, or operable to support a means for obtaining, from the DT entity and based on the request, a response that indicates the one or more estimated measurement values. The RACH manager 635 is capable of, configured to, or operable to support a means for outputting, based on the one or more estimated measurement values, a RACH message to the cell.

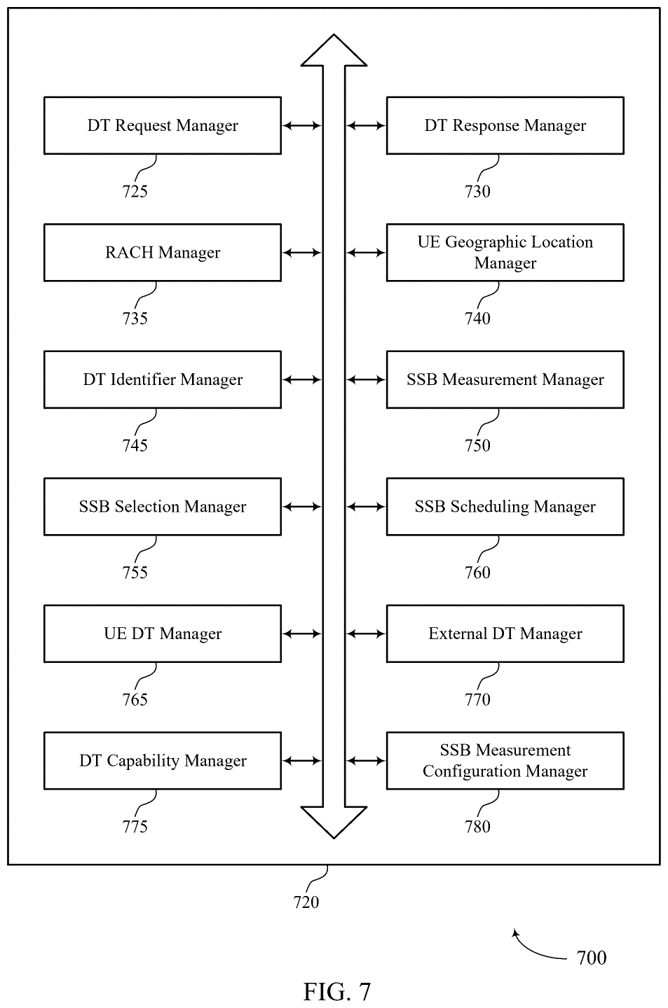

FIG. 7 shows a block diagram 700 of a communications manager 720 that supports DT-assisted random access in accordance with one or more aspects of the present disclosure. The communications manager 720 may be an example of aspects of a communications manager 520, a communications manager 620, or both, as described herein. The communications manager 720, or various components thereof, may be an example of means for performing various aspects of DT-assisted random access as described herein. For example, the communications manager 720 may include a DT request manager 725, a DT response manager 730, a RACH manager 735, a UE geographic location manager 740, a DT identifier manager 745, an SSB measurement manager 750, an SSB selection manager 755, an SSB scheduling manager 760, a UE DT manager 765, an external DT manager 770, a DT capability manager 775, an SSB measurement configuration manager 780, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The DT request manager 725 is capable of, configured to, or operable to support a means for outputting a request for a DT entity associated with a cell to provide, based on a geographic location of the UE, one or more estimated measurement values associated with one or more SSBs, where the one or more SSBs are associated with the cell. The DT response manager 730 is capable of, configured to, or operable to support a means for obtaining, from the DT entity and based on the request, a response that indicates the one or more estimated measurement values. The RACH manager 735 is capable of, configured to, or operable to support a means for outputting, based on the one or more estimated measurement values, a RACH message to the cell.

In some examples, the request includes at least one of: one or more generated measurement values associated with the one or more SSBs and associated indices of the one or more SSBs; an identifier of the cell; an indication of a transmission power level of the one or more SSBs; an estimate of the geographic location of the UE; a velocity of the UE; a trajectory of the UE; or antenna information associated with the UE.

In some examples, the UE geographic location manager 740 is capable of, configured to, or operable to support a means for identifying the geographic location of the UE. In some examples, the DT identifier manager 745 is capable of, configured to, or operable to support a means for identifying, based on the geographic location of the UE, the DT entity, where outputting the request is based on identifying the DT entity.

In some examples, the SSB measurement manager 750 is capable of, configured to, or operable to support a means for generating one or more measurement values of the one or more SSBs based on obtaining the one or more SSBs from the cell, where the response includes one or more of: an estimated pathloss value of each of the one or more SSBs; an estimated pathloss of one or more additional SSBs associated with the cell; an offset value for each of the one or more SSBs in comparison to the one or more measurement values; a validity window associated with the one or more estimated measurement values; a suggested SSB associated with the cell; a recommendation for the UE to perform additional measurements associated with the cell prior to outputting the RACH message; a recommendation for the UE to skip one or more additional measurements associated with the cell prior to outputting the RACH message; or a timing advance to apply to the RACH message.

In some examples, the RACH manager 735 is capable of, configured to, or operable to support a means for identifying a failure of the RACH message, where the RACH message is associated with a first transmission power level. In some examples, the RACH manager 735 is capable of, configured to, or operable to support a means for outputting, subsequent to the RACH message, a second RACH message, where the second RACH message is associated with a second transmission power level, and where the response is indicative of the second transmission power level.

In some examples, to support outputting the second RACH message, the RACH manager 735 is capable of, configured to, or operable to support a means for outputting the second RACH message via a second RACH occasion, where outputting the RACH message includes outputting the RACH message via a first RACH occasion, and where the response indicates the second RACH occasion.

In some examples, the SSB measurement manager 750 is capable of, configured to, or operable to support a means for generating one or more measurement values associated with the one or more SSBs based on obtaining the one or more SSBs from the cell, where the response indicates a confidence level associated with the one or more estimated measurement values. In some examples, the SSB selection manager 755 is capable of, configured to, or operable to support a means for selecting a SSB based on the one or more measurement values, the one or more estimated measurement values, the confidence level, or any combination thereof, where outputting the RACH message includes outputting the RACH message via a RACH occasion associated with the SSB.

In some examples, to support selecting the SSB, the SSB selection manager 755 is capable of, configured to, or operable to support a means for selecting the SSB based on the one or more estimated measurement values in accordance with the confidence level exceeding a threshold level.

In some examples, the SSB measurement manager 750 is capable of, configured to, or operable to support a means for augmenting the one or more measurement values based on the one or more estimated measurement values and based on the confidence level exceeding a threshold level, where selecting the SSB is based on the augmented one or more measurement values.

In some examples, the response indicates a confidence level associated with the one or more estimated measurement values, and the SSB measurement manager 750 is capable of, configured to, or operable to support a means for generating, based on the confidence level being below a threshold level, one or more measurement values associated with the one or more SSBs or one or more additional SSBs associated with the cell based on obtaining the one or more SSBs or the one or more additional SSBs from the cell. In some examples, the SSB selection manager 755 is capable of, configured to, or operable to support a means for selecting a SSB based on the one or more measurement values, where outputting the RACH message includes outputting the RACH message via a RACH occasion associated with the SSB.

In some examples, the SSB scheduling manager 760 is capable of, configured to, or operable to support a means for identifying that the cell will not transmit the one or more SSBs during a period of time, where outputting the request is based on the identifying.

In some examples, to support outputting the request, the UE DT manager 765 is capable of, configured to, or operable to support a means for outputting the request to the DT entity stored in memory of the UE, and where obtaining the response includes obtaining the response from the DT entity stored in the memory of the UE.

In some examples, to support outputting the request, the external DT manager 770 is capable of, configured to, or operable to support a means for outputting, via a network connection, the request to an external server configured to host the DT entity, and where obtaining the response includes obtaining the response via the network connection from the external server configured to host the DT entity.

In some examples, the DT capability manager 775 is capable of, configured to, or operable to support a means for outputting, to the cell and after performing a random access procedure with the cell, first control signaling that indicates a capability of the UE to use the DT entity to receive estimated measurements for the cell. In some examples, the SSB measurement configuration manager 780 is capable of, configured to, or operable to support a means for obtaining, from the cell and based on the first control signaling, second control signaling that indicates a measurement reporting configuration associated with the DT entity.

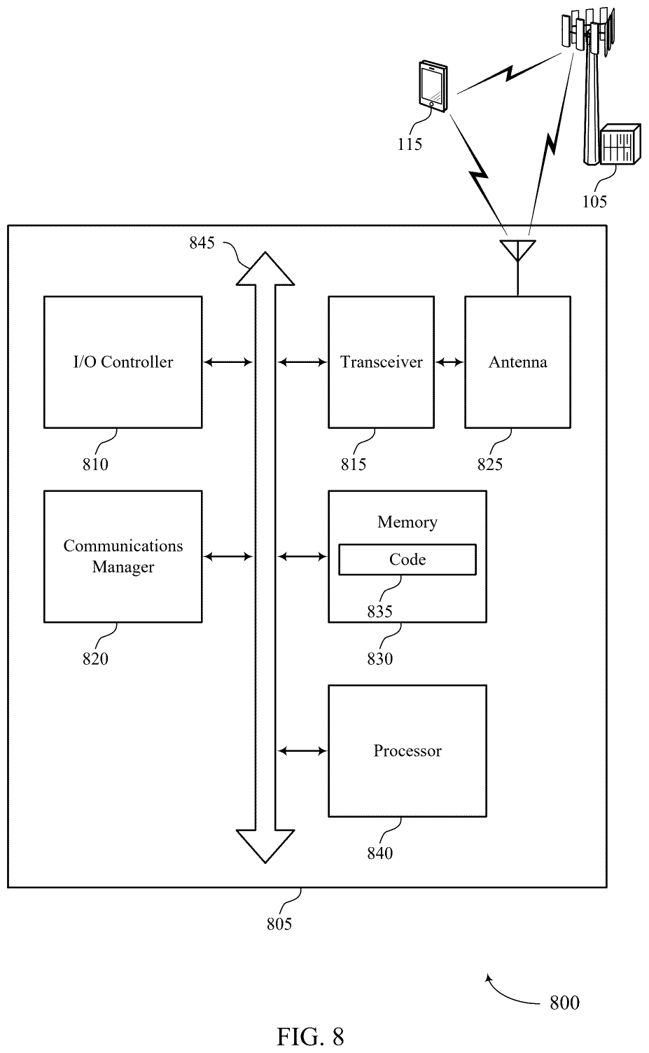

FIG. 8 shows a diagram of a system 800 including a device 805 that supports DT-assisted random access in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting DT-assisted random access). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for outputting a request for a DT entity associated with a cell to provide, based on a geographic location of the UE, one or more estimated measurement values associated with one or more SSBs, where the one or more SSBs are associated with the cell. The communications manager 820 is capable of, configured to, or operable to support a means for obtaining, from the DT entity and based on the request, a response that indicates the one or more estimated measurement values. The communications manager 820 is capable of, configured to, or operable to support a means for outputting, based on the one or more estimated measurement values, a RACH message to the cell.

By including or configuring the communications manager 820 in accordance with examples as described herein, the device 805 may support techniques for improved communication reliability, reduced latency, reduced power consumption, more efficient utilization of communication resources, or improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of DT-assisted random access as described herein, or the at least one processor 840 and the at least one memory 830 may be otherwise configured to, individually or collectively, perform or support such operations.

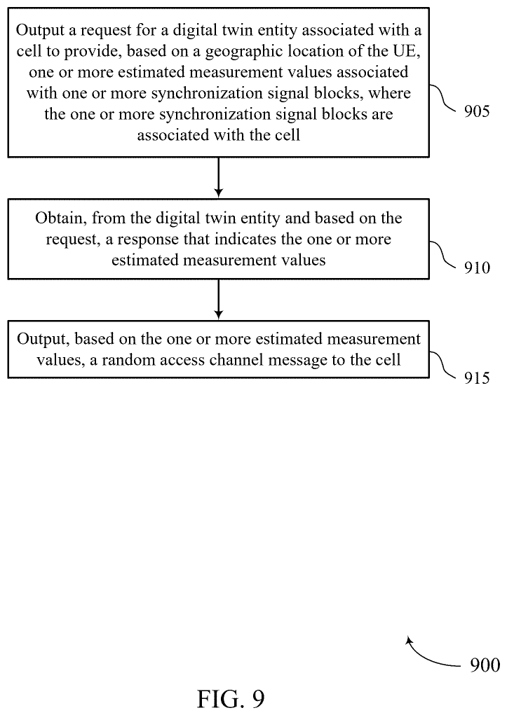

FIG. 9 shows a flowchart illustrating a method 900 that supports DT-assisted random access in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include outputting a request for a DT entity associated with a cell to provide, based on a geographic location of the UE, one or more estimated measurement values associated with one or more SSBs, where the one or more SSBs are associated with the cell. The operations of 905 may be performed in accordance with examples as disclosed herein. In some examples, aspects of the operations of 905 may be performed by a DT request manager 725 as described with reference to FIG. 7.

At 910, the method may include obtaining, from the DT entity and based on the request, a response that indicates the one or more estimated measurement values. The operations of 910 may be performed in accordance with examples as disclosed herein. In some examples, aspects of the operations of 910 may be performed by a DT response manager 730 as described with reference to FIG. 7.

At 915, the method may include outputting, based on the one or more estimated measurement values, a RACH message to the cell. The operations of 915 may be performed in accordance with examples as disclosed herein. In some examples, aspects of the operations of 915 may be performed by a RACH manager 735 as described with reference to FIG. 7.

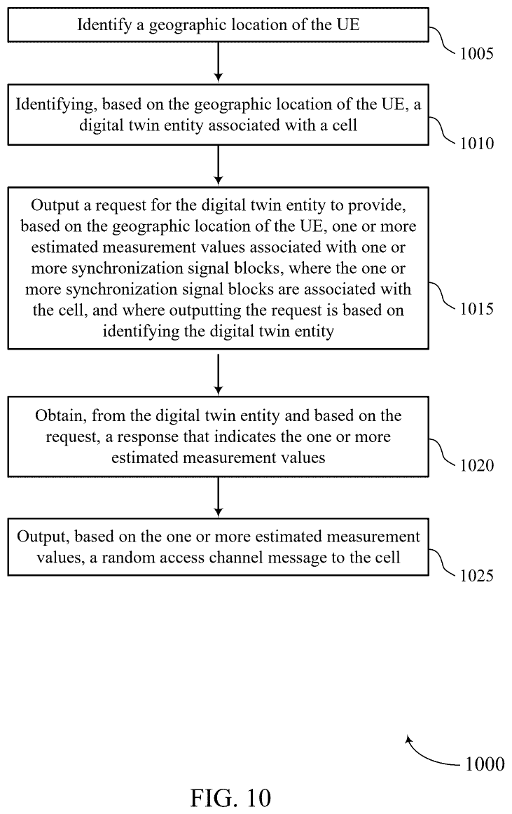

FIG. 10 shows a flowchart illustrating a method 1000 that supports DT-assisted random access in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include identifying the geographic location of the UE. The operations of 1005 may be performed in accordance with examples as disclosed herein. In some examples, aspects of the operations of 1005 may be performed by a UE geographic location manager 740 as described with reference to FIG. 7.

At 1010, the method may include identifying, based on the geographic location of the UE, a DT entity associated with a cell. The operations of 1010 may be performed in accordance with examples as disclosed herein. In some examples, aspects of the operations of 1010 may be performed by a DT identifier manager 745 as described with reference to FIG. 7.

At 1015, the method may include outputting a request for the DT entity to provide, based on the geographic location of the UE, one or more estimated measurement values associated with one or more SSBs, where the one or more SSBs are associated with the cell, and where outputting the request is based on identifying the DT entity. The operations of 1015 may be performed in accordance with examples as disclosed herein. In some examples, aspects of the operations of 1015 may be performed by a DT request manager 725 as described with reference to FIG. 7.

At 1020, the method may include obtaining, from the DT entity and based on the request, a response that indicates the one or more estimated measurement values. The operations of 1020 may be performed in accordance with examples as disclosed herein. In some examples, aspects of the operations of 1020 may be performed by a DT response manager 730 as described with reference to FIG. 7.

At 1025, the method may include outputting, based on the one or more estimated measurement values, a RACH message to the cell. The operations of 1025 may be performed in accordance with examples as disclosed herein. In some examples, aspects of the operations of 1025 may be performed by a RACH manager 735 as described with reference to FIG. 7.

The following provides an overview of aspects of the present disclosure:

Aspect 1: A method for wireless communications at a UE, comprising: outputting a request for a DT entity associated with a cell to provide, based at least in part on a geographic location of the UE, one or more estimated measurement values associated with one or more SSBs, wherein the one or more SSBs are associated with the cell; obtaining, from the DT entity and based at least in part on the request, a response that indicates the one or more estimated measurement values; and outputting, based at least in part on the one or more estimated measurement values, a RACH message to the cell.

Aspect 2: The method of aspect 1, wherein the request comprises at least one of: one or more generated measurement values associated with the one or more SSBs and associated indices of the one or more SSBs; an identifier of the cell; an indication of a transmission power level of the one or more SSBs; an estimate of the geographic location of the UE; a velocity of the UE; a trajectory of the UE; or antenna information associated with the UE.

Aspect 3: The method of any of aspects 1 through 2, further comprising: identifying the geographic location of the UE; and identifying, based on the geographic location of the UE, the DT entity, wherein outputting the request is based at least in part on identifying the DT entity.

Aspect 4: The method of any of aspects 1 through 3, further comprising: generating one or more measurement values of the one or more SSBs based at least in part on obtaining the one or more SSBs from the cell, and wherein the response includes one or more of: an estimated pathloss value of each of the one or more SSBs; an estimated pathloss of one or more additional SSBs associated with the cell; an offset value for each of the one or more SSBs in comparison to the one or more measurement values; a validity window associated with the one or more estimated measurement values; a suggested SSB associated with the cell; a recommendation for the UE to perform additional measurements associated with the cell prior to outputting the RACH message; a recommendation for the UE to skip one or more additional measurements associated with the cell prior to outputting the RACH message; or a timing advance to apply to the RACH message.

Aspect 5: The method of any of aspects 1 through 4, further comprising: identifying a failure of the RACH message, wherein the RACH message is associated with a first transmission power level; and outputting, subsequent to the RACH message, a second RACH message, wherein the second RACH message is associated with a second transmission power level, and wherein the response is indicative of the second transmission power level.

Aspect 6: The method of aspect 5, wherein outputting the second RACH message comprises: outputting the second RACH message via a second RACH occasion, wherein outputting the RACH message comprises outputting the RACH message via a first RACH occasion, and wherein the response indicates the second RACH occasion.

Aspect 7: The method of any of aspects 1 through 6, further comprising: generating one or more measurement values associated with the one or more SSBs based at least in part on obtaining the one or more SSBs from the cell, wherein the response indicates a confidence level associated with the one or more estimated measurement values; and selecting a SSB based at least in part on the one or more measurement values, the one or more estimated measurement values, the confidence level, or a combination thereof, wherein outputting the RACH message comprises outputting the RACH message via a RACH occasion associated with the SSB.

Aspect 8: The method of aspect 7, wherein selecting the SSB comprises: selecting the SSB based at least in part on the one or more estimated measurement values based at least in part on the confidence level exceeding a threshold level.

Aspect 9: The method of any of aspects 7 through 8, further comprising: augmenting the one or more measurement values based at least in part on the one or more estimated measurement values and based at least in part on the confidence level exceeding a threshold level, wherein selecting the SSB is based at least in part on the augmented one or more measurement values.

Aspect 10: The method of any of aspects 1 through 9, further comprising: generating, based at least in part on a confidence level indicated by the response being below a threshold level, one or more measurement values associated with the one or more SSBs or one or more additional SSBs associated with the cell based at least in part on obtaining the one or more SSBs or the one or more additional SSBs from the cell, wherein the confidence level is associated with the one or more estimated measurement values; and selecting a SSB based at least in part on the one or more measurement values, wherein outputting the RACH message comprises outputting the RACH message via a RACH occasion associated with the SSB.

Aspect 11: The method of any of aspects 1, 3, 5, 6, or 8, further comprising: identifying that the cell will not transmit the one or more SSBs during a period of time, wherein outputting the request is based at least in part on the identifying.

Aspect 12: The method of any of aspects 1 through 11, wherein outputting the request comprises: outputting the request to the DT entity stored in memory of the UE, and wherein obtaining the response comprises obtaining the response from the DT entity stored in the memory of the UE.

Aspect 13: The method of any of aspects 1 through 11, wherein outputting the request comprises: outputting, via a network connection, the request to an external server hosting the DT entity, and wherein obtaining the response comprises obtaining the response via the network connection from the external server hosting the DT entity.

Aspect 14: The method of any of aspects 1 through 13, further comprising: outputting, to the cell and after performing a random access procedure with the cell, first control signaling that indicates a capability of the UE to use the DT entity to receive estimated measurements for the cell; and obtaining, from the cell and based at least in part on the first control signaling, second control signaling that indicates a measurement reporting configuration associated with the DT entity.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
output a request for a digital twin entity associated with a cell to provide, based at least in part on a geographic location of the UE, one or more estimated measurement values associated with one or more synchronization signal blocks, wherein the one or more synchronization signal blocks are associated with the cell;
obtain, from the digital twin entity and based at least in part on the request, a response that indicates the one or more estimated measurement values; and
output, based at least in part on the one or more estimated measurement values, a random access channel message to the cell.

2. The UE of claim 1, wherein the request comprises at least one of: one or more generated measurement values associated with the one or more synchronization signal blocks and associated indices of the one or more synchronization signal blocks; an identifier of the cell; an indication of a transmission power level of the one or more synchronization signal blocks; an estimate of the geographic location of the UE; a velocity of the UE; a trajectory of the UE; or antenna information associated with the UE.

3. The UE of claim 1, wherein the one or more processors are individually or collectively further operable to execute the code to cause the UE to:
identify the geographic location of the UE; and
identify, based on the geographic location of the UE, the digital twin entity, wherein outputting the request is based at least in part on identifying the digital twin entity.

4. The UE of claim 1, wherein the one or more processors are individually or collectively further operable to execute the code to cause the UE to:
generate one or more measurement values of the one or more synchronization signal blocks based at least in part on obtaining the one or more synchronization signal blocks from the cell, wherein the response includes one or more of:
an estimated pathloss value of each of the one or more synchronization signal blocks; an estimated pathloss of one or more additional synchronization signal blocks associated with the cell; an offset value for each of the one or more synchronization signal blocks in comparison to the one or more measurement values; a validity window associated with the one or more estimated measurement values; a suggested synchronization signal block associated with the cell; a recommendation for the UE to perform additional measurements associated with the cell prior to outputting the random access channel message; a recommendation for the UE to skip one or more additional measurements associated with the cell prior to outputting the random access channel message; or a timing advance to apply to the random access channel message.

5. The UE of claim 1, wherein the one or more processors are individually or collectively further operable to execute the code to cause the UE to:
identify a failure of the random access channel message, wherein the random access channel message is associated with a first transmission power level; and
output, subsequent to the random access channel message, a second random access channel message, wherein the second random access channel message is associated with a second transmission power level, and wherein the response is indicative of the second transmission power level.

6. The UE of claim 5, wherein, to output the second random access channel message, the one or more processors are individually or collectively operable to execute the code to cause the UE to:
output the second random access channel message via a second random access channel occasion, wherein the one or more processors are individually or collectively operable to execute the code to cause the UE to output the random access channel message via a first random access channel occasion, and wherein the response indicates the second random access channel occasion.

7. The UE of claim 1, wherein the one or more processors are individually or collectively further operable to execute the code to cause the UE to:
generate one or more measurement values associated with the one or more synchronization signal blocks based at least in part on obtaining the one or more synchronization signal blocks from the cell, wherein the response indicates a confidence level associated with the one or more estimated measurement values; and
select a synchronization signal block based at least in part on the one or more measurement values, the one or more estimated measurement values, the confidence level, or any combination thereof, wherein, to output the random access channel message, the one or more processors are individually or collectively operable to execute the code to cause the UE to output the random access channel message via a random access channel occasion associated with the synchronization signal block.

8. The UE of claim 7, wherein, to select the synchronization signal block, the one or more processors are individually or collectively operable to execute the code to cause the UE to:
select the synchronization signal block based at least in part on the one or more estimated measurement values in accordance with the confidence level exceeding a threshold level.

9. The UE of claim 7, wherein the one or more processors are individually or collectively further operable to execute the code to cause the UE to:
augment the one or more measurement values based at least in part on the one or more estimated measurement values and based at least in part on the confidence level exceeding a threshold level, wherein the one or more processors are individually or collectively operable to execute the code to cause the UE to select the synchronization signal block based at least in part on the augmented one or more measurement values.

10. The UE of claim 1, wherein the response indicates a confidence level associated with the one or more estimated measurement values, wherein the one or more processors are individually or collectively further operable to execute the code to cause the UE to:
generate, based at least in part on the confidence level being below a threshold level, one or more measurement values associated with the one or more synchronization signal blocks or one or more additional synchronization signal blocks associated with the cell based at least in part on obtaining the one or more synchronization signal blocks or the one or more additional synchronization signal blocks from the cell; and
select a synchronization signal block based at least in part on the one or more measurement values, wherein the one or more processors are individually or collectively operable to execute the code to cause the UE to output the random access channel message via a random access channel occasion associated with the synchronization signal block.

11. The UE of claim 1, wherein the one or more processors are individually or collectively further operable to execute the code to cause the UE to:
identify that the cell will not transmit the one or more synchronization signal blocks during a period of time, wherein the one or more processors are individually or collectively operable to execute the code to cause the UE to output the request based at least in part on the identifying.

12. The UE of claim 1, wherein, to output the request, the one or more processors are individually or collectively operable to execute the code to cause the UE to:
output the request to the digital twin entity stored in memory of the UE, wherein the one or more processors are individually or collectively operable to execute the code to cause the UE to obtain the response from the digital twin entity stored in the memory of the UE.

13. The UE of claim 1, wherein, to output the request, the one or more processors are individually or collectively operable to execute the code to cause the UE to:
output, via a network connection, the request to an external server configured to host the digital twin entity, wherein the one or more processors are individually or collectively operable to execute the code to cause the UE to obtain the response via the network connection from the external server configured to host the digital twin entity.

14. The UE of claim 1, wherein the one or more processors are individually or collectively further operable to execute the code to cause the UE to:
output, to the cell and after performing a random access procedure with the cell, first control signaling that indicates a capability of the UE to use the digital twin entity to receive estimated measurements for the cell; and
obtain, from the cell and based at least in part on the first control signaling, second control signaling that indicates a measurement reporting configuration associated with the digital twin entity.

15. A method for wireless communications at a user equipment (UE), comprising:
outputting a request for a digital twin entity associated with a cell to provide, based at least in part on a geographic location of the UE, one or more estimated measurement values associated with one or more synchronization signal blocks, wherein the one or more synchronization signal blocks are associated with the cell;
obtaining, from the digital twin entity and based at least in part on the request, a response that indicates the one or more estimated measurement values; and
outputting, based at least in part on the one or more estimated measurement values, a random access channel message to the cell.

16. The method of claim 15, wherein the request comprises at least one of: one or more generated measurement values associated with the one or more synchronization signal blocks and associated indices of the one or more synchronization signal blocks; an identifier of the cell; an indication of a transmission power level of the one or more synchronization signal blocks; an estimate of the geographic location of the UE; a velocity of the UE; a trajectory of the UE; or antenna information associated with the UE.

17. The method of claim 15, further comprising:
identifying the geographic location of the UE; and
identifying, based on the geographic location of the UE, the digital twin entity, wherein outputting the request is based at least in part on identifying the digital twin entity.

18. The method of claim 15, further comprising:
generating one or more measurement values of the one or more synchronization signal blocks based at least in part on obtaining the one or more synchronization signal blocks from the cell, wherein the response includes one or more of:
an estimated pathloss value of each of the one or more synchronization signal blocks; an estimated pathloss of one or more additional synchronization signal blocks associated with the cell; an offset value for each of the one or more synchronization signal blocks in comparison to the one or more measurement values; a validity window associated with the one or more estimated measurement values; a suggested synchronization signal block associated with the cell; a recommendation for the UE to perform additional measurements associated with the cell prior to outputting the random access channel message; a recommendation for the UE to skip one or more additional measurements associated with the cell prior to outputting the random access channel message; or a timing advance to apply to the random access channel message.

19. The method of claim 15, further comprising:
identifying a failure of the random access channel message, wherein the random access channel message is associated with a first transmission power level; and
outputting, subsequent to the random access channel message, a second random access channel message, wherein the second random access channel message is associated with a second transmission power level, and wherein the response is indicative of the second transmission power level.

20. A non-transitory computer-readable medium storing code for wireless communications, the code comprising instructions executable by one or more processors to:
output, by a user equipment (UE), a request for a digital twin entity associated with a cell to provide, based at least in part on a geographic location of the UE, one or more estimated measurement values associated with one or more synchronization signal blocks, wherein the one or more synchronization signal blocks are associated with the cell;
obtain, from the digital twin entity and based at least in part on the request, a response that indicates the one or more estimated measurement values; and
output, based at least in part on the one or more estimated measurement values, a random access channel message to the cell.
